(19) United States
(12) Patent Application Publication
(10) Pub. No.: US 2025/0094919 A1
(43) Pub. Date: Mar. 20, 2025

(54) IMAGE-FORMED PRODUCT ORDERING SYSTEM

(71) Applicant: Konica Minolta, Inc., Tokyo (JP)

(72) Inventors: Toshiaki MIYAKI, Yokohama-shi (JP); Takahiro KUSUNOKI, Tokyo (JP); Masahiro YAMAGUCHI, Tokyo (JP); Takashi FUJIWARA, Tokyo (JP); Toshiyuki TSUKAHARA, Yokohama-shi (JP); Akihiro HONYA, Tokyo (JP)

(21) Appl. No.: 18/882,300

(22) Filed: Sep. 11, 2024

(30) Foreign Application Priority Data
Sep. 15, 2023 (JP) 2023-150388

(51) Int. Cl. G06Q 10/0835; G06Q 10/087; G06Q 30/0601

(52) U.S. Cl. CPC G06Q 10/0835; G06Q 10/087; G06Q 30/0601

(57) ABSTRACT

Disclosed is an image-formed product ordering system including: a first hardware processor that acquires image forming job information from an orderer terminal of an orderer of an image-formed product; an image former that generates the image-formed product by forming an image on a recording medium, based on the received image forming job information; and an ejector that ejects the image-formed product. Only a deliverer associated with the image-formed product is able to receive the image-formed product ejected from the ejector.

### CROSS-REFERENCE TO RELATED APPLICATIONS

The entire disclosure of Japanese Patent Application No. 2023-150388 filed on Sep. 15, 2023, including description, claims, drawings and abstract, is incorporated herein by reference.

### BACKGROUND OF THE INVENTION

### Technical Field

The present invention relates to an image-formed product ordering system.

### Description of Related Art

Conventionally, Japanese Unexamined Patent Publication No. 2002-334236 describes that a print shop is requested to perform printing and a delivery company delivers a printed product.

### SUMMARY OF THE INVENTION

By the way, in the case where printing is requested to a print shop and a delivery company delivers a printed product, since a worker of the print shop can see the printed product, there is a case where it is desirable to make a contract such as confidentiality with the printing company. Therefore, from the orderer's point of view, time and effort for the contract become complicated.

In addition, if the printing company makes such a contract, it is necessary to strictly manage the printing house. Therefore, a load increases from the viewpoint of a printing company.

An object of the present invention is to reduce complication of a contract or the like for an orderer and a load on a printing company in generating an image-formed product.

To achieve at least one of the abovementioned objects, according to an aspect of the present invention, image-formed product ordering system reflecting one aspect of the present invention includes: a first hardware processor that acquires image forming job information from an orderer terminal of an orderer of an image-formed product; an image former that generates the image-formed product by forming an image on a recording medium, based on the received image forming job information; and an ejector that ejects the image-formed product, wherein only a deliverer associated with the image-formed product is able to receive the image-formed product ejected from the ejector.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a block diagram illustrating a configuration of an image-formed product ordering system;

FIG. 2 is a block diagram illustrating a configuration of a management server;

FIG. 3 is a block diagram illustrating a configuration of an orderer terminal device;

FIG. 4 is a block diagram illustrating a configuration of the image forming apparatus;

FIG. 5 is a block diagram illustrating a configuration of an image forming station management apparatus;

FIG. 6 is a block diagram illustrating a configuration of a deliverer terminal device;

FIG. 7 is an image diagram of an image forming station;

FIG. 8 is a flowchart illustrating image-formed product ordering processing; and

FIG. 9 is a flowchart showing the image-formed product ordering processing.

### DETAILED DESCRIPTION

Hereinafter, one or more embodiments of the present invention will be described with reference to the drawings. However, the scope of the invention is not limited to the disclosed embodiments.

### <Image-Formed Product Ordering System>

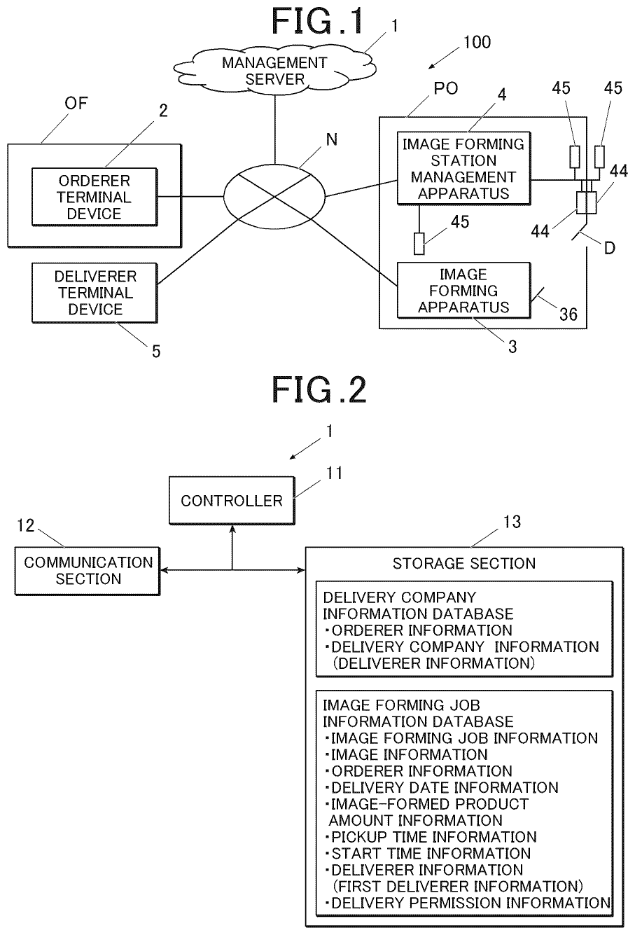

First, a configuration of an image-formed product ordering system 100 will be described with reference to FIG. 1. As illustrated in FIG. 1, the image-formed product ordering system 100 includes a management server 1, an orderer terminal device 2, an image forming apparatus 3, an image forming station management apparatus 4, and a deliverer terminal device 5.

The management server 1, the orderer terminal device 2, the image forming apparatus 3, the image forming station management apparatus 4, the deliverer terminal device 5, and the like transmit and receive information via the communication network N. The various types of information will be described later.

The management server 1 is an apparatus that manages image forming job information ordered from orderers and the like. The orderer is a person who orders an image-formed product. The delivery company is a company of a person (deliverer) who delivers the image-formed product. The deliverer is assumed to be, for example, a gig worker. The management server 1 is configured with an on-premise or cloud device.

The orderer terminal device 2 is a terminal used by an orderer to order an image-formed product. For example, the orderer terminal device 2 is a notebook PC (personal computer) or the like. For example, the orderer terminal device 2 is placed in the orderer's office OF.

The image forming apparatus 3 is an apparatus that forms an image on a recording medium based on image forming job information. The recording medium is, for example, any of various types of paper, a sealed letter, or a postcard. The postcard includes a postcard glued so as to conceal part of information. The image forming apparatus 3 is placed in an image forming station PO which will be described later. The image forming apparatus 3 is managed by an administrator of the image forming apparatus 3.

The image forming station management apparatus 4 is an apparatus that manages the image forming station PO in which the image forming apparatus 3 is disposed. The security of the image forming station PO is secured by the image forming station management apparatus 4. Similarly, the image forming station management apparatus 4 is disposed in an image forming station PO described later.

The deliverer terminal device 5 is a device held by a deliverer for delivery. For example, the deliverer terminal device 5 is a tablet terminal or the like. The deliverer can confirm the delivery destination, the delivery date, and the like using the deliverer terminal device 5. Furthermore, the deliverer terminal device 5 is configured to acquire location information, and the location information of the deliverer who holds the deliverer terminal device 5 is acquired.

The communication network N is a local area network (LAN), a wide area network (WAN), the Internet, or the like.

### <Management Server>

Next, a configuration of the management server 1 will be described with reference to FIG. 2. As illustrated in FIG. 2, the management server 1 includes a controller 11 (i.e., a first hardware processor), a communication section 12, and a storage section 13.

The controller 11 is constituted by a central processing unit (CPU), a random access memory (RAM), and the like. The CPU of the controller 11 reads various programs stored in the storage section 13, develops the programs in the RAM, executes various processes in accordance with the developed programs, and controls the operation of each section of the management server 1.

The controller 11 functions as an acquisition section that acquires image forming job information from the orderer terminal of the orderer of the image-formed product.

The controller 11 functions as a selection section to select a deliverer to pick up and deliver the image-formed product.

The controller 11 functions as a first controller that controls the delivery of the image-formed product based on the delivery permission information for permitting the delivery of the image-formed product from the orderer terminal.

The communication section 12 can transmit and receive various signals and various data to and from other devices and the like connected via the communication network N.

The storage section 13 is composed of a nonvolatile semiconductor memory, a hard disk and the like, and stores various information such as various programs to be executed by the controller 11 and parameters necessary for executing the programs.

The storage section 13 includes a delivery company information database (DB) and an image forming job information database.

The delivery company information database is a database for managing a delivery company for each orderer.

The orderer information includes the orderer ID, name, address, and the like of the orderer.

The delivery company information is information for managing the deliverer information for each company to which the deliverer belongs. The deliverer information includes a deliverer ID and a name.

The image forming job information database is a database for managing image forming job information ordered by an orderer.

The image forming job information includes image information, orderer information, delivery date information, image-formed product amount information, pickup time information, start time information, deliverer information, delivery permission information, and the like.

The image information is information (image data) such as an image and characters to be formed.

The orderer information is information indicating an orderer who has ordered each piece of image forming job information, and is, for example, an orderer ID.

The delivery date information is information indicating a delivery date to an orderer of a recording medium (image-formed product) on which the image information has been formed.

The image-formed product amount information is, for example, information indicating the amount of image-formed products such as the number of sheets or weight.

The pickup time information is information indicating the time at which the deliverer picks up the image-formed product from the image forming station PO and starts the delivery.

The start time information is information indicating a start time at which the image forming apparatus 3 is caused to form an image on a recording medium.

The deliverer information (first deliverer information) is information on a deliverer who delivers the image-formed product. For example, it is a deliverer ID. Note that the later-described second deliverer information is deliverer information formed as an image on a recording medium based on the first deliverer information.

The delivery permission information is information indicating that the deliverer is permitted to deliver the image-formed product.

### <Orderer Terminal Device>

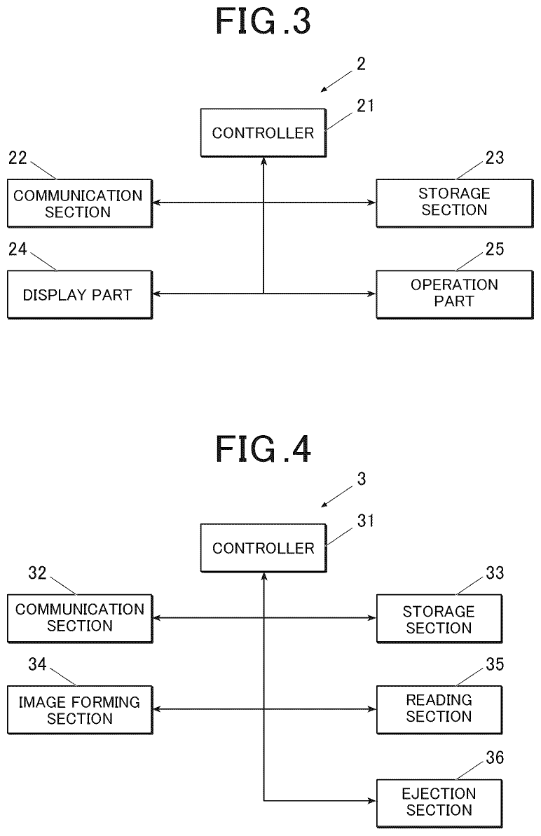

Next, a configuration of the orderer terminal device 2 will be described with reference to FIG. 3. As illustrated in FIG. 3, the orderer terminal device 2 includes a controller 21, a communication section 22, a storage section 23, a display part 24, and an operation part 25.

The orderer inputs image information, orderer information, and delivery date information using the orderer terminal device 2, and transmits image forming job information in order to place an order for an image-formed product.

The controller 21 includes a CPU, a RAM, and the like. The CPU of the controller 21 reads various programs stored in the storage section 23, develops the programs in the RAM, executes various processes in accordance with the developed programs, and controls the operation of each section of the orderer terminal device 2.

The communication section 22 can transmit and receive various signals and various data to and from other devices and the like connected via the communication network N.

The storage section 23 is composed of a nonvolatile semiconductor memory, a hard disk and the like, and stores various programs to be executed by the controller 11, parameters necessary for executing the programs and the like.

The display part 24 is formed with a monitor such as a liquid crystal display (LCD), and displays various screens and the like in accordance with an instruction of a display signal input from the controller 21.

The operation part 25 is a keyboard, a pointing device, a touch screen, or the like. The keyboard includes cursor keys, number input keys, various function keys, and the like. The pointing device is a mouse or the like. The touch screen is laminated on the surface of the display part 24. The operation part 25 is configured to be operable by an operator. The operation part 25 outputs various signals based on an operation performed by the operator to the controller 21.

### <Image Forming Apparatus>

Next, the configuration of the image forming apparatus 3 will be described with reference to FIG. 4. As illustrated in FIG. 4, the image forming apparatus 3 includes a controller 31 (i.e., a second hardware processor), the communication section 32, a storage section 33, an image forming section 34 (image former), a reading section 35 (reader), and a ejection section 36 (ejector).

The image forming apparatus 3 forms an image on a recording medium based on image forming job information.

The image forming apparatus 3 uses the image forming job information in a state in which the image forming job information cannot be secondarily used.

The controller 31 includes a CPU, a RAM, and the like. The CPU of the controller 31 reads various programs stored in the storage section 33, develops the programs in the RAM, executes various processes in accordance with the developed programs, and controls the operation of each section of the image forming apparatus 3.

The controller 31 functions as a first transmission section that transmits the read image to the orderer terminal.

The controller 31 functions as an inspection section that inspects the presence or absence of abnormality of the image-formed product from the read image.

The controller 31 functions as a second controller to cause the image forming section to start image formation based on the image forming job information on the basis of the pickup time by the deliverer.

The controller 31 functions as a second acquisition section which acquires the image forming job information on the basis of the pickup time by the deliverer.

The controller 11 of the management server 1 may have the function of the controller 31, and the controller 11 may control the operation of each section of the image forming apparatus 3 via the communication network N.

The communication section 32 can transmit and receive various signals and various data to and from other devices and the like connected via the communication network N.

The storage section 33 is composed of a nonvolatile semiconductor memory, a hard disk and the like, and stores various programs to be executed by the controller 11, parameters necessary for executing the programs and the like.

The image forming section 34 forms an image on a recording medium such as a sheet supplied from a sheet feeding section (not illustrated) by an electrophotographic method. The image forming section 34 forms an image on the basis of the image forming job information received from the management server 1.

The image forming section 34 includes photosensitive drums corresponding to respective colors of yellow, magenta, cyan, and black, an intermediate transfer belt, a secondary transfer roller, a fixing section, and the like.

The image forming section 34 generates an image-formed product by forming an image on a recording medium based on the received image forming job information.

The reading section 35 is a device that reads a surface of a recording medium on which an image is formed by the image forming section 34 and which is conveyed.

The reading section 35 generates a read image by reading an image-formed product.

The ejection section 36 is a tray or the like for ejecting a recording medium on which an image has been formed by the image forming section 34 and which has passed through the reading section 35.

### <Image Forming Station Management Apparatus>

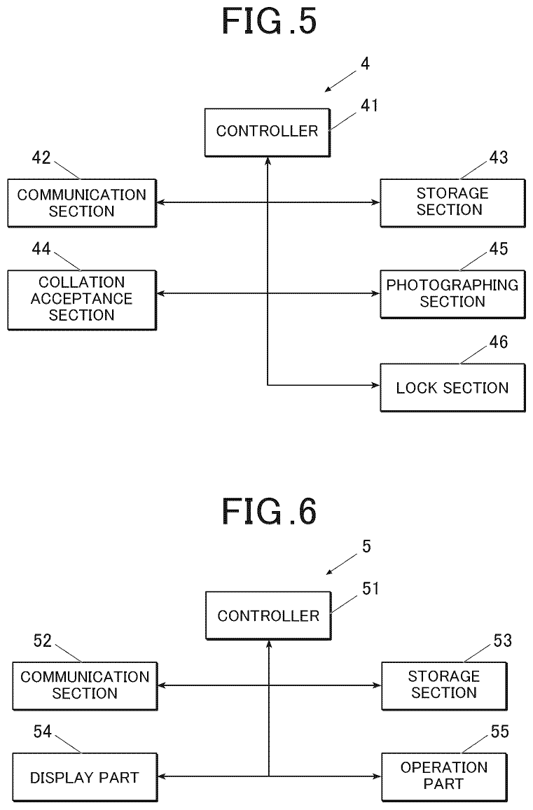

Next, the configuration of the image forming station management apparatus 4 will be described with reference to FIG. 5. As illustrated in FIG. 5, the image forming station management apparatus 4 includes a controller 41 (i.e., a third hardware processor), the communication section 42, a storage section 43, a collation acceptance section 44, and an photographing section 45 (image capturer).

The image forming station management apparatus 4 manages the image forming station PO. The image forming station management apparatus 4 manages the image forming station PO by allowing only the deliverer associated with the image-formed product to enter the image forming station PO, confirming that the deliverer has the image formed product, and allowing the deliverer to exit.

The controller 41 includes a CPU, a RAM, and the like. The CPU of the controller 41 reads various programs stored in the storage section 43, develops the programs in the RAM, executes various processes in accordance with the developed programs, and controls the operation of each section of the image forming station management apparatus 4.

The controller 41 functions as a second transmitting section which transmits the photographing data obtained by photographing from the start of execution of the image forming job information to the pickup to the orderer terminal.

The communication section 42 can transmit and receive various signals and various data to and from other devices and the like connected via the communication network N.

The storage section 43 is composed of a nonvolatile semiconductor memory, a hard disk and the like, and stores various programs to be executed by the controller 11, parameters necessary for executing the programs and the like.

The collation acceptance section 44 accepts information for collation displayed on the deliverer terminal device 5 to be described later or information for collation image-formed on an image-formed product. For example, the collation acceptance section 44 is a quick response (QR) code (R) reading device or the like. Note that the collation acceptance section 44 may accept not only the QR code but also various kinds of wireless communication via the communication section 52. Furthermore, the collation acceptance section 44 is not limited to a QR code, and may perform various kinds of authentication using a password or the like.

The photographing section 45 is a monitoring camera or the like installed near an entrance/exit of the image forming station PO or near the image forming apparatus 3 in the image forming station PO.

The photographing section 45 functions as a photographing section that photographs the image forming apparatus 3.

The lock section 46 (lock) is a device that restricts entrance and exit at the image forming station PO. The lock section 46 is provided at a door D of an image forming station PO where the image forming apparatus 3 is arranged. The lock section 46 is unlocked by key information given only to the deliverer associated with the image-formed product.

### <Deliverer Terminal Device>

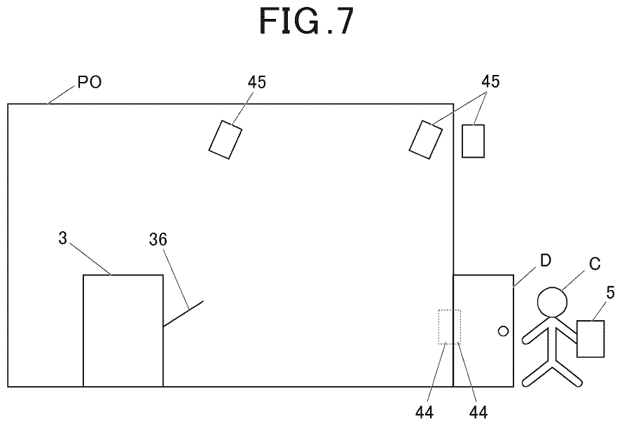

Next, a configuration of the deliverer terminal device 5 will be described with reference to FIG. 6. As illustrated in FIG. 6, the deliverer terminal device 5 includes a controller 51, a communication section 52, a storage section 53, a display part 54, and an operation part 55.

The deliverer enters the image forming station PO and delivers the image-formed product to a specified address (e.g., the address of the orderer) by using the deliverer terminal device 5.

The deliverer terminal device 5 holds a deliverer ID for each device, and the deliverer terminal device 5 is managed using a deliverer ID.

The controller 51 includes a CPU, a RAM, and the like. The CPU of the controller 51 reads various programs stored in the storage section 53, develops the programs in the RAM, executes various processes according to the developed programs, and controls the operation of each section of the deliverer terminal device 5.

The communication section 52 can transmit and receive various signals and various data to and from other devices and the like connected via the communication network N.

The storage section 53 is composed of a nonvolatile semiconductor memory, a hard disk and the like, and stores various programs to be executed by the controller 11, parameters necessary for executing the programs and the like.

The display part 54 is configured by a monitor such as an LCD, and displays various screens and the like in accordance with an instruction of a display signal input from the controller 51.

The operation part 55 is a keyboard, a pointing device, a touch screen, or the like. The keyboard includes cursor keys, number input keys, various function keys, and the like. The pointing device is a mouse or the like. The touch screen is laminated on the surface of the display part 54. The operation part 55 is configured to be operable by an operator. The operation part 55 outputs various signals based on an operation performed by the operator to the controller 51.

### <Image Forming Station>

Next, the image forming station PO will be described with reference to FIG. 7.

When the deliverer C holds key information such as a QR code displayed on the display part 54 of the deliverer terminal device 5 over the collation acceptance section 44 and thus it is confirmed that the deliverer corresponds to the image-formed product, the lock section 46 provided on the door D is unlocked. Then, the deliverer C can enter the image forming station PO and receives the image-formed product from the ejection section 36 of the image forming apparatus 3.

When the deliverer C holds key information such as a QR code formed as an image on the received image-formed product over the collation acceptance section 44 and thus it is confirmed that the deliverer C has correctly received the image-formed product, the lock section 46 provided on the door D is unlocked. Then, the deliverer C can leave the image forming station PO and delivers the image-formed product.

At the same time as the entrance and exit, the photographing section 45 photographs the movement of the periphery of the image forming apparatus 3 and the entrance and exit of the deliverer C, and takes a log.

### <Image-Formed Product Ordering Processing>

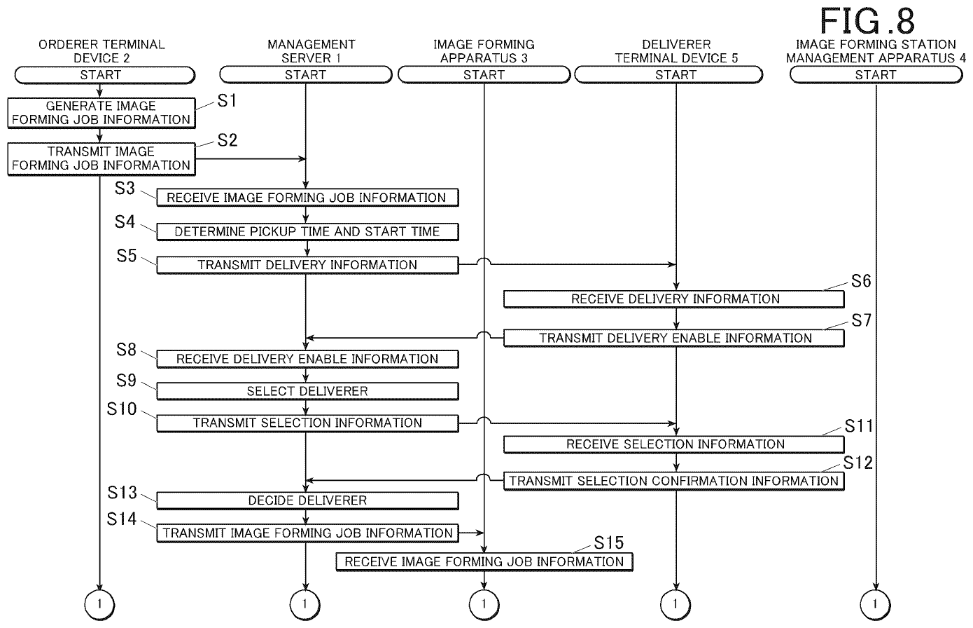

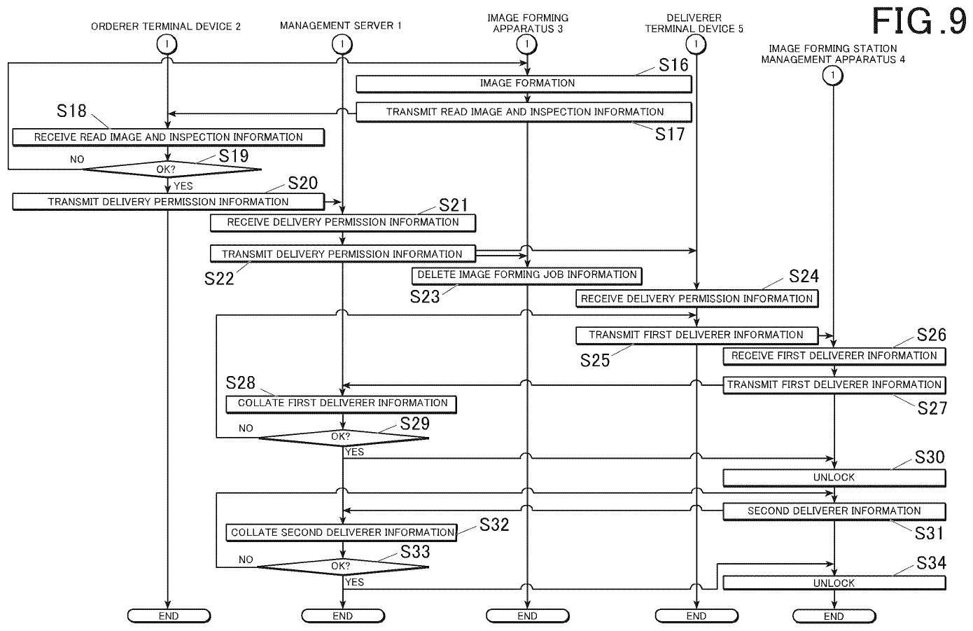

Next, the image-formed product ordering processing will be described with reference to FIG. 8 and FIG. 9. The image-formed product ordering processing is processing in which an orderer orders an image-formed product and a deliverer delivers the image-formed product. The image-formed product ordering processing is executed by the management server 1, the orderer terminal device 2, the image forming apparatus 3, the image forming station management apparatus 4, and the deliverer terminal device 5 cooperating with each other.

First, when the orderer inputs information relating to the image forming job such as image information, orderer information, and delivery date information by using the operation part 25 of the orderer terminal device 2, the controller 21 generates image forming job information (step S1).

Next, the controller 21 transmits the image forming job information to the management server 1 via the communication section 22 (step S2).

Next, the controller 11 receives the image forming job information from the orderer terminal device 2 via the communication section 12 (step S3). Upon reception, the controller 11 calculates the image-formed product amount information on the basis of the image forming job information.

Next, the controller 11 calculates the pickup time based on the delivery date information, and determines the start time to start image formation in accordance with the pickup time (step S4). That is, at this time, the pickup time information and the start time information are generated.

Next, the controller 11 transmits the delivery information (orderer information, delivery date information, pickup time information, and image-formed product amount information) to the deliverer terminal device 5 of the deliverer ID linked to the orderer ID via the communication section 12 (step S5). For example, the delivery information is transmitted to the deliverer terminal device 5 possessed by each of a plurality of gig worker (deliverers).

Next, the controller 51 receives the delivery information from the management server 1 via the communication section 52, and causes the display part 54 to display the delivery information (step S6). The deliverer confirms the delivery information displayed on the display part 54 and determines whether or not delivery is possible.

Next, when the deliverer presses a delivery enable button displayed on the display part 54 using the operation part 55 of the deliverer terminal device 5, the controller 51 transmits delivery enable information (deliverer information and location information), which is information indicating that the deliverer can deliver the image-formed product, to the management server 1 via the communication section 52 (step S7).

Next, the controller 11 receives the delivery enable information from the deliverer terminal device 5 via the communication section 12 (step S8).

Next, the controller 11 selects a deliverer (step S9). For example, the controller 11 may select a deliverer within a predetermined distance from the image forming station PO based on the location information. In addition, the controller 11 may select a deliverer in consideration of an operation route of the deliverer. Furthermore, for example, the controller 11 may select a deliverer whose evaluation is higher by a predetermined degree or more. At this time, the controller 11 generates selection information indicating that a deliverer has been selected.

Next, the controller 11 transmits the selection information to the deliverer terminal device 5 of the selected deliverer via the communication section 12 (step S10).

Next, the controller 51 receives the selection information from the management server 1 via the communication section 52 (step S11).

Next, when the deliverer presses a selection confirmation button displayed on the display part 54 using the operation part 55 of the deliverer terminal device 5, the controller 51 transmits, to the management server 1 via the communication section 52, selection confirmation information indicating that the selection has been confirmed (step S12). Upon pressing the selection confirmation button or the like, the deliverer heads for the image forming station PO in time for the pickup time.

Next, the controller 11 decides the deliverer (step S13). The controller 11 generates deliverer information (first deliverer information). The controller 11 adds the deliverer information to the image forming job information.

Thus, the efficiency of delivery is improved due to, for example, an increase in the probability that a deliverer close to the image forming station PO will perform delivery.

Next, the controller 11 transmits the image forming job information to the image forming apparatus 3 via the communication section 12 (step S14).

Next, the controller 31 receives image forming job information from the management server 1 via the communication section 32 (step S15).

Next, based on the start time information included in the image forming job information, the controller 31 causes the image forming section 34 to form an image of the image information on the recording media based on the image forming job information at the start time (step S16). In addition, the controller 31 forms second deliverer information on the recording medium. The second deliverer information is information on an image formed on a recording medium on the basis of the first deliverer information determined in step S13.

Thus, a time period from ejection of an image-formed product formed on a recording medium to the ejection section 36 until delivery of the image-formed product can be a limited short time period.

Next, the controller 31 causes the reading section 35 to read the recording medium on which the image is formed, and generates a read image. The controller 31 performs inspection by comparing the read image with the correct image, and generates inspection information. The inspection information includes, for example, “image to be formed is missing” and “dirt adheres to the recording medium”. The controller 31 transmits the read image and the inspection information to the orderer terminal device 2 via the communication section 32 (step S17).

Note that the controller 31 may transmit only the read image or only the inspection information. The read images transmitted by the controller 31 may be read images of all the recording media on which images are formed, or may be only a read image determined to have abnormality by inspection.

Next, the controller 21 receives the read image and the inspection information from the image forming apparatus 3 via the communication section 22, and causes the display part 24 to display the read image and the inspection information (step S18).

Next, when the confirmation result of the read image and the inspection information is input by the orderer using the operation part 25 of the orderer terminal device 2, the controller 21 determines the confirmation result of the read image and the inspection information (step S19).

If the controller 21 determines that the confirmation result on the read image and the inspection information is OK (step S19; YES), the controller 21 advances the image-formed product ordering processing to step S20. In a case where it is determined that the confirmation result regarding the read image and the inspection information is NG (step S19; NO), the controller 21 advances the image-formed product ordering processing to step S16 via the communication section 22.

Thus, although the administrator of the image forming station PO cannot confirm the read image and the inspection information of the image-formed product on which the image is formed, the quality of the image-formed product required by the orderer is guaranteed.

Next, the controller 21 transmits the delivery permission information to the management server 1 via the communication section 22 (step S20).

Next, the controller 11 receives the delivery permission information from the orderer terminal device 2 via the communication section 12 (step S21).

Next, the controller 11 transmits the delivery permission information to the image forming apparatus 3 and the deliverer terminal device 5 via the communication section 12 (step S22).

Next, when the controller 31 receives the delivery permission information from the management server 1 via the communication section 32, the controller 31 deletes the image forming job information received in step 10 from the storage section 33 (step S23). For example, the controller 31 performs overwriting with information in which predetermined information is not included.

Thus, the image forming job information can be prevented from remaining in the image forming apparatus 3.

Next, the controller 51 receives the delivery permission information from the management server 1 via the communication section 52, and causes the display part 54 to display the information (step S24). The deliverer checks the delivery permission information displayed on the display part 54 and recognizes that the permission for delivery has been given.

When the deliverer arrives at the image forming station PO, the controller 51 allows the display part 54 of the deliverer terminal device 5 to display key information such as a QR code indicating the deliverer ID, and the deliverer holds the key information over the collation acceptance section 44. That is, the controller 51 transmits the first deliverer information to the image forming station management apparatus 4 (step S25).

Next, the controller 41 receives the first deliverer information from the deliverer terminal device 5 (step S26).

Next, the controller 41 transmits the first deliverer information to the management server 1 via the communication section 42 (step S27).

Next, the controller 11 receives the first deliverer information from the image forming station management apparatus 4 via the communication section 12, and collates the received first deliverer information with the first deliverer information determined in step S13 (step S28).

If the two pieces of first deliverer information are the same, the controller 11 determines OK (step S29).

If it is determined to be OK (step S29; YES), the controller 11 advances the image-formed product ordering processing to step S30, based on the control by the controller 11 via the communication section 12. When it is determined as NG (step S29; NO), the controller 11 advances the image-formed product ordering processing to step S25 based on the control by the controller 11 via the communication section 12.

Next, the controller 41 unlocks the lock section 46 provided on the door D of the image forming station PO (step S30).

The deliverer enters the image forming station PO and receives the image-formed product from the ejection section 36 of the image forming apparatus 3. When the deliverer enters, the lock section 46 provided on the door D is locked.

Thus, only the deliverer of the delivery company associated with the orderer can enter the image forming station PO.

Upon receiving the image-formed product, the deliverer faces the door D, causes a QR code or the like formed as an image on the image-formed product to be displayed, and holds the QR code or the like over the collation acceptance section 44. That is, the controller 41 receives the second deliverer information. Thereafter, the controller 41 transmits the second deliverer information to the management server 1 via the communication section 42 (step S31).

Next, the controller 11 receives the second deliverer information from the image forming station management apparatus 4 via the communication section 12, and collates the received second deliverer information with the first deliverer information determined in step S13 (step S32).

If the first deliverer information and the second deliverer information are the same, the controller 11 determines that it is OK (step S33).

If it is determined to be OK (step S33; YES), the controller 11 advances the image-formed product ordering processing to step S34, based on the control by the controller 11 via the communication section 12. When it is determined as NG (step S33; NO), the controller 11 advances the image-formed product ordering processing to step S31 based on the control by the controller 11 via the communication section 12.

Next, the controller 41 unlocks the lock section 46 provided on the door D of the image forming station PO (step S34).

The deliverer leaves the image forming station PO and delivers the image-formed product. When the deliverer leaves, the lock section 46 provided on the door D is locked.

Thus, the deliverer of the delivery company associated with the orderer correctly receives the image-formed product from the image forming station PO and exits.

According to the embodiment as described above, only the deliverer associated with the image-formed product can receive the image-formed product ejected from the ejection section 36. Specifically, only the deliverer decided in step S13 can enter the image forming station PO by unlocking the lock section 46 of the image forming station PO in step S30. Thus, only the deliverer can receive the image-formed product. In addition, when the deliverer receives the associated image-formed product, re-opens the lock section 46 of the image forming station PO in Step S34, and exits, it is confirmed that the associated image-formed product has been received.

### <Others>

Although the image-formed product on which the image has been formed is sent to the address of the orderer included in the orderer information in the storage section 13 in the embodiment described above, the present invention is not limited to this example. For example, an address designated by the orderer may be set as the delivery destination.

Further, the controller 41 may transmit, to the orderer terminal device 2, the photograph taken from the start of execution of the image forming job information (step S16) to the pickup (step S34). At this time, the controller 41 functions as a second transmission section.

In addition, a step of causing the orderer to confirm that there is no person in the image forming station PO before the image formation may be added to the above-described embodiment.

Specifically, a predetermined time before the start time, the controller 31 of the image forming apparatus 3 transmits, to the orderer terminal device 2, information indicating that image formation is to be performed at the start time and the current situation inside the image forming station PO photographed by the photographing section 45. When the orderer confirms that there is no person in the image forming station PO by using the orderer terminal device 2, the orderer transmits instruction information for instructing execution of image formation to the image forming apparatus 3. The controller 31 of the image forming apparatus 3 causes the image forming section 34 to form an image based on the instruction information instructing execution of image formation. On the contrary, when the orderer confirms that there is a person in the image forming station PO by using the orderer terminal device 2, the orderer transmits instruction information for stopping the execution of the image formation to the image forming apparatus 3. Based on the instruction information instructing to stop image formation, the controller 31 of the image forming apparatus 3 causes the image forming section 34 to stop image formation.

In the above specific example, the orderer checks that no person is present in the image forming station PO, but a human detection sensor or the like may be provided in the image forming station PO, and the controller 41 of the image forming station management apparatus 4 connected to the human detection sensor may automatically determine that no person is present in the image forming station PO.

In addition, in the above-described embodiment, in step S16, the controller 31 causes the image forming section 34 to form an image at the start time. However, the controller 31 may acquire the image forming job information based on the pickup time by the deliverer. At this time, the controller 31 functions as a second acquisition section.

Further, in the above embodiment, the deliverer is decided based on the calculated pickup time. However, the deliverer may be decided first, and the start time may be calculated based on the schedule of the deliverer in consideration of the delivery date.

Specifically, the controller 11 of the management server 1 acquires the schedule of the deliverer from the deliverer terminal device 5, and selects the deliverer from the availability of the schedule and the like. Next, the controller 11 transmits the selection information and the delivery information to the deliverer terminal device 5. Next, the deliverer checks the delivery date information included in the delivery information, and the time of arrival at the image forming station PO (pickup time) is transmitted to the management server 1. Next, the controller 11 calculates the start time so that the image formation is completed in accordance with the received pickup time.

In the above-described embodiment, the number of image forming stations PO is one, but may be two or more. The controller 11 of the management server 1 may determine the image forming station PO to form an image on the basis of the orderer's address or a specified address.

Further, a plurality of image forming apparatuses 3 may be provided. Thus, even when a certain image forming apparatus 3 cannot be used due to a paper jam or the like, the controller 31 causes another usable image forming apparatus 3 to form an image, thereby reducing the number of cases where image formation is not completed during the pickup time of the deliverer.

Furthermore, although in the above-described embodiment, in step S23, the controller 31 deletes the image forming job information upon receiving the delivery permission information from the management server 1, it is not limited thereto.

For example, in step S16, the controller 31 may erase the image forming job information when the controller 31 determines that there is no problem by inspecting the read image after the final sheet is ejected. That is, in the image-formed product ordering processing, steps S17 to S22 are not performed, and the controller 31 determines the read image, and when determining that there is no problem, transmits the delivery permission information to the deliverer terminal device 5, and when determining that there is a problem, causes image formation to be performed again.

Further, in the embodiment described above, the lock section 46 is provided at the image forming station PO, but it is not limited thereto. For example, the lock section 46 may be provided in the ejection section 36 of the image forming apparatus 3 so that the deliverer cannot take out the image-formed product from the ejection section 36 in a locked state.

Furthermore, in the embodiment described above, an inspection is performed by comparing a read image and a correct image in a certain job. That is, the inspection is performed for each piece of image forming job information.

The controller 11 of the management server 1 may calculate the probability of occurrence of waste by acquiring and accumulating the results of such inspection from the image forming apparatus 3. The controller 11 may calculate the probability of occurrence of waste for each sheet type. The controller 11 may calculate the probability of occurrence of waste for each image forming apparatus 3. Since the probability of occurrence of waste is calculated, various time periods can be set in consideration of the time required for reprinting.

In addition, in the image forming apparatus 3, the controller 31 may purge the waste paper in which abnormality is confirmed as a result of the inspection performed by comparing the read image with the correct image to a ejection section different from the ejection section 36, and only the printed product which is confirmed to be normal may be ejected to the ejection section 36 which is the pickup place.

In addition, the purged waste sheet may be cut by a cutter or the like.

In the above-described embodiment, the controller 11 calculates the pickup time based on the delivery date information and determines the start time to start the image formation in accordance with the pickup time. However, the start time to start the image formation may be determined based on not only the pickup time but also the occurrence probability of the waste.

Alternatively, the controller 31 may acquire the image forming job information on the basis of not only the pickup time but also the above-described probability of occurrence of waste.

Furthermore, in a case where image formation cannot be started at the start time, for example, because the start time determined based on the pickup time or the probability of occurrence of waste is a time earlier than the current time, the controller 11 may transmit, to the orderer terminal device 2, information for requesting modification of the delivery date.

### <Effect>

As described above, the image-formed product ordering system 100 includes the acquisition section (management server 1; controller 11) which acquires image forming job information from the orderer terminal (orderer terminal device 2) of the orderer of the image-formed product, the image forming section (image forming apparatus 3; image forming section 34) which generates the image-formed product by forming the image on the recording medium based on the received image forming job information, and the ejection section (image forming apparatus 3; ejection section 36) which ejects the image-formed product, and only the deliverer associated with the image-formed product can receive the image-formed product ejected from the ejection section.

Therefore, the orderer does not needs to make a contract such as a confidentiality contract with the printing company, which reduces complication of the contract or the like for the orderer. The printing company does not needs to make a contract for confidentiality or the like with the orderer, thereby reducing the management load (employees, equipment, and the like) on the printing company.

Furthermore, the image-formed product ordering system 100 includes the reading section 35 that reads the image-formed product and generates a read image, the first transmission section (controller 31) that transmits the read image to the orderer terminal, and the first controller (controller 11) that controls the delivery of the image-formed product on the basis of the delivery permission information that allows the delivery of the image-formed product from the orderer terminal.

Thus, although the orderer can confirm the read image and the administrator of the image forming station PO cannot inspect the image-formed product, the quality of the image-formed product is guaranteed.

Furthermore, the image-formed product ordering system 100 further includes an inspection section (controller 31) that inspects the presence or absence of abnormality of the image-formed product from the read image, and the first transmission section (controller 31) further transmits information on the result of the inspection.

Thus, the orderer can confirm the inspection result, and the administrator of the image forming station PO cannot inspect the image-formed product, but the quality of the image-formed product is guaranteed.

The image-formed product ordering system 100 is further provided with a photographing section 45 for photographing the image forming section and a second transmission section (controller 41) for transmitting photographing data obtained by photographing from the execution start of the image forming job information to the delivery to the orderer terminal.

Thus, the security of the image-formed product is guaranteed.

Furthermore, the image-formed product ordering system 100 includes a second controller (controller 31) that causes the image forming section to start image formation based on the image forming job information, based on the pickup time by the deliverer.

Thus, the time from the placement of the image-formed product at the ejection section 36 to the delivery thereof can be made a limited short time, thus ensuring the security of the image-formed product.

Furthermore, the image-formed product ordering system 100 includes a second acquisition section (controller 31) that acquires the image forming job information on the basis of the pickup time by the deliverer.

Thus, the time from the placement of the image-formed product at the ejection section 36 to the delivery thereof can be made a limited short time, thus ensuring the security of the image-formed product.

The image-formed product ordering system 100 further includes a selection section (controller 11) to select a deliverer to pick up the image-formed product, and the selection section selects the deliverer on the basis of the pickup time of the image-formed product.

Thus, the efficiency of delivery is improved due to, for example, an increase in the probability that a deliverer close to the image forming station PO will perform delivery.

Furthermore, the image-formed product ordering system 100 includes the lock section 46 which is provided at the door of the room in which the image forming section is arranged and restricts entrance and exit, and the key information which is given only to the deliverer associated with the image-formed product, and the lock section is unlocked by the key information.

Thus, the security of the image forming station PO is ensured, and the image-formed product can be prevented from being delivered to anyone other than the predetermined deliverer.

For example, in the above description, an example in which a hard disk, a semiconductor nonvolatile memory, or the like is used as a computer-readable medium of the program according to the present invention has been disclosed, but the present invention is not limited to this example. As another computer-readable medium, a portable recording medium such as a CD-ROM can be applied.

In addition, the detailed configuration and the detailed operation of each device can be appropriately changed without departing from the spirit and scope of the present invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-150388 filed on Sep. 15, 2023 is incorporated herein by reference in its entirety.

What is claimed is:

1. An image-formed product ordering system comprising:
a first hardware processor that acquires image forming job information from an orderer terminal of an orderer of an image-formed product;
an image former that generates the image-formed product by forming an image on a recording medium, based on the received image forming job information; and
an ejector that ejects the image-formed product, wherein
only a deliverer associated with the image-formed product is able to receive the image-formed product ejected from the ejector.

2. The image-formed product ordering system according to claim 1, further comprising:
a reader that reads the image-formed product to generate a read image; and
a second hardware processor that transmits the read image to the orderer terminal, wherein
the first hardware processor controls delivery of the image-formed product, based on delivery permission information for permitting the delivery of the image-formed product from the orderer terminal.

3. The image-formed product ordering system according to claim 2, wherein the second hardware processor inspects presence or absence of abnormality of the image-formed product from the read image and transmits information on a result of inspection.

4. The image-formed product ordering system according to claim 1, further comprising:
an image capturer that photographs the image former; and
a third hardware processor that transmits, to the orderer terminal, photographed data obtained by photographing from start of execution of the image forming job information to pickup.

5. The image-formed product ordering system according to claim 1, further comprising a second hardware processor that causes the image former to start image formation based on the image forming job information, based on a pickup time by the deliverer.

6. The image-formed product ordering system according to claim 5, wherein the second hardware processor causes the image former to start the image formation based on the image forming job information, also based on a probability of occurrence of waste.

7. The image-formed product ordering system according to claim 1, further comprising a second hardware processor that acquires the image forming job information, based on a pickup time by the deliverer.

8. The image-formed product ordering system according to claim 7, wherein the second hardware processor acquires the image forming job information, also based on a probability of occurrence of waste.

9. The image-formed product ordering system according to claim 1, wherein the first hardware processor selects the deliverer that picks up and delivers the image-formed product, based on a pickup time of the image-formed product.

10. The image-formed product ordering system according to claim 1, further comprising:
a lock that is provided at a door of a room in which the image former is arranged and that restricts entrance and exit; and
key information provided only to the deliverer associated with the image-formed product, wherein
the lock is unlocked by the key information.
